(19) United States
(12) Patent Application Publication
(10) Pub. No.: US 2010/0075092 A1
(43) Pub. Date: Mar. 25, 2010

(54) RADIATION CURABLE PRESSURE SENSITIVE ADHESIVE ROOFING SYSTEM

(76) Inventors: Eli Kendra, Saint Charles, IL (US); Dennis Booth, Grass Lake, MI (US); Paul Snowhite, Dexter, MI (US); James Woods, Jackson, MI (US)

Correspondence Address: VIVACQUA LAW, PLLC, 455 East Eisenhower Parkway, Suite 200, ANN ARBOR, MI, 48108, US

(21) Appl. No.: 12/596,369

(22) PCT Filed: Apr. 16, 2008
(86) PCT No.: PCT/US08/60500

§ 371 Date: Nov. 11, 2009

Related U.S. Application Data
(60) Provisional application No. 60/912,096, filed on Apr. 16, 2007.

(51) Int. Cl. B32B 33/00; C08J 3/28; B05D 3/02

(52) U.S. Cl. 428/41.8; 522/149; 522/64; 522/42; 427/385.5

(57) ABSTRACT

A radiation curable pressure sensitive adhesive composition is provided. The radiation curable pressure sensitive adhesive composition is used to adhere a roofing membrane to a roof deck in roofing applications. The composition includes a radiation curable rubber, at least one stabilizer, at least one tackifier, at least one flexibilizer, at least one antioxidant, at least one plasticizer, and at least one photoinitiator.

### CROSS-REFERENCE TO RELATED APPLICATIONS

This application claims the benefit of U.S. Provisional Application No. 60/912,096, filed on Apr. 16, 2007. The disclosure of the above application is incorporated herein by reference.

### FIELD

The present invention relates to radiation curable compositions, and more particularly to a radiation curable pressure sensitive adhesive (PSA) system for use in roofing applications.

### BACKGROUND

Three basic methods of applying single ply membranes to roofing decks are known in the roofing industry. These methods include a mechanically fastened roofing method, a ballasted roofing method, and a fully adhered roofing method. Mechanically fastened roofing methods include using fasteners such as nails or screws to attach the membrane to the roofing deck. Additionally, various sealant caulks or heat welding of the membrane materials are employed to seal the membrane. Ballasted roofing methods rely upon gravel or other ballast to hold down the roofing membrane. The ballasted roofing application methods also require mechanical fasteners.

Fully adhered roofing systems do not require the use of mechanical fasteners or sealant materials and are becoming more popular in the roofing industry. In one common method of fully adhered roofing, an adhesive is applied to the roof deck and then the membrane is pressed onto the adhesive after a solvent flashes off and the adhesive dries. In an alternative method, the membrane is pre-coated on one side with a pressure sensitive adhesive (PSA) and a release liner is attached to the PSA. At the job site, the release liner is removed and the membrane applied directly to the roof deck. The PSA then adheres to the base substrate materials.

While useful for its intended purpose, there is room in the art for a PSA composition and system that provides increased cohesive strength, higher shear strengths at elevated temperatures, and increased adhesiveness or tackiness.

### SUMMARY

The present invention provides a hot melt pressure sensitive adhesive composition which is cured by exposure to UV radiation in an in-line process using automated equipment and which may be applied to a substrate. The composition provides heat and chemical resistance, appropriate bonding to substrates, increased cohesive strength, higher shear strengths at elevated temperatures, and increased adhesiveness or tackiness over prior art compositions.

According to one aspect of the present invention, a UV curable pressure sensitive adhesive (PSA) composition is provided for use as an adhesive between a substrate and a roofing membrane. The composition generally includes a UV or radiation curable rubber present in an amount from about 10% to about 30% by weight, at least one plasticizer present in an amount from about 12% to about 46% by weight, at least one stabilizer present in an amount from about 0.1% to about 1% by weight, at least one antioxidant present in an amount from about 0.1% to about 1% by weight, at least one tackifier present in an amount from about 19% to about 43% by weight, at least one photoinitiator present in an amount from about 0.5% to about 2.2% by weight, and at least one flexibilizer present in an amount from about 4% to about 6% by weight. In addition, the use of inerting gasses such as nitrogen or carbon dioxide to prevent or control the level of oxygen inhibition may be employed during the curing phase.

In an exemplary embodiment, the UV curable rubber comprises a styrene-butadiene-styrene block copolymer such as Kraton DKX222CS, present in an amount from about 10% to about 30% by weight. It should be appreciated that more than one UV curable rubber may be employed in any given formulation of the composition without departing from the scope of the present invention.

An exemplary plasticizer for inclusion in the composition is selectable from a group including a polybutene homopolymer such as H-300 Poly present in an amount from about 12.7% to about 45.2% by weight; and a napthenic oil such as NP-22 Oil present in an amount of about 4% to about 6% by weight. It should be appreciated that more than one plasticizer may be employed in any given formulation of the composition without departing from the scope of the present invention.

An exemplary stabilizer for inclusion in the composition is a distearyl pentaerythritol diphosphite such as Weston 618F present in an amount from about 0.3% to about 0.5% by weight. It should be appreciated that more than one stabilizer may be employed in any given formulation of the composition without departing from the scope of the present invention.

An exemplary antioxidant for inclusion in the composition is selectable from a group including a hindered phenol such as Irganox 1010 present in an amount from about 0.3% to about 0.5% by weight or Irganox 1726 present in an amount from about 0.3% to about 0.6% by weight. It should be appreciated that more than one antioxidant may be employed in any given formulation of the composition without departing from the scope of the present invention.

An exemplary tackifier for inclusion in the composition is selectable from a group including a cycloaliphatic hydrocarbon resin such as Escorez 5340 present in an amount from about 9.6% to about 17.1% by weight; an alkylated aromatic hydrocarbon resin such as Nevchem 140 present in an amount from about 6.7% to about 12.0% by weight; a hydrocarbon resin such as Novares C-160 present in an amount from about 1.9% to about 3.3% by weight; an aliphatic phenol such as Escorez 1304 present in an amount from about 19.8% to about 40.0% by weight; and an aromatically modified C-5 hydrocarbon resin such as Wingtack 86 present in an amount from about 19.8% to about 40% by weight. It should be appreciated that more than one tackifier may be employed in any given formulation of the composition without departing from the scope of the present invention.

An exemplary photoinitiator for inclusion in the composition is selectable from a group including a bis acyl phosphine (BAPO) such as Irgacure 819 present in an amount from about 0.5% to about 0.8% by weight; a benzyldimethyl-ketal such as Irgacure 651 present in an amount from about 0.4% to about 0.6% by weight; and an alpha hydroxyketone (1-hydroxy-cyclohexyl-phenyl-ketone) such as Irgacure 184 present in an amount from about 1.0% to about 1.1% by weight. It should be appreciated that more than one photoinitiator may be employed in any given formulation of the composition without departing from the scope of the present invention. Inerting gasses can also be used to control the level of surface cure thus affecting the adhesion, tack, or quick-stick of the cured film.

An exemplary flexibilizer for inclusion in the composition is selectable from a group including a low molecular weight (Mw 51-55K) polyisobutylene such as Oppanol B-12 present in an amount from about 7.9% to about 44.9% by weight or such as Oppanol B-10 present in an amount from about 4.9% to about 5.3% by weight. It should be appreciated that more than one flexibilizer may be employed in any given formulation of the composition without departing from the scope of the present invention.

The composition may further include substances for flow resistance, bodying agents, and cured strength builders.

An exemplary flow resistance substance for inclusion in the composition is a hydrophilic fumed silica such as Aerosil R-202 present in an amount from about 0.0% to about 0.7% by weight. It should be appreciated that more than one flow resistance substance may be employed in any given formulation of the composition without departing from the scope of the present invention.

An exemplary bodying agent for inclusion in the composition is selectable from a group including an isoprene and isobutylene co-polymer such as Exxon Butyl 065 present in an amount from about 0% to about 5.0% by weight; a brominated butyl such as Exxpro 3433 present in an amount of about 0% to about 6.6%; a SIS co-polymer (tri-block) such as Kraton D-1163 present in an amount from about 0% to about 3.9% by weight; and an SEP co-polymer (di-block) such as Kraton G-1701 present in an amount from about 0% to about 7.1%. It should be appreciated that more than one flow resistance substance may be employed in any given formulation of the composition without departing from the scope of the present invention.

An exemplary cured strength builder for inclusion in the composition is selectable from a group including a propene rich amorphous polyalphaolefin such as Vestoplast 750 present in an amount from about 0% to about 6.6% by weight or such as Exxpro Vestoplast 703 present in an amount of about 0.0% to about 6.6%. It should be appreciated that more than one cured strength builder may be employed in any given formulation of the composition without departing from the scope of the present invention.

The composition may also include a number of additives selectable for certain desirable properties.

The composition is preferably employed as part of a roofing tape system wherein the composition is located between a roofing membrane and a release liner.

In one embodiment of the present invention, a hot melt applicator applies a thin layer of the composition to the roofing membrane. The composition is then preferably cured in place by UV radiation. A release liner is then applied to the exposed composition.

The UV radiation source preferably comprises a UV light source such as a UV lamp. After curing, the composition effectively bonds to the roofing membrane and provides a tacky surface and increased resistance to heat and chemicals over the use of conventional compositions.

The UV curable PSA roofing system of the present invention may be employed in various roofing applications to effectively secure a roofing membrane to a substrate without the use of on-site hot melt applicators. Such applications may include cover strips for overlay or repair, cover stops, or metal edge tie-ins; seam tapes for seaming and splicing roofing membranes; flashings; reinforced perimeter strips; and die cut sections for pipe boots, T-joints, and corners. Additionally, the UV curable PSA roofing system of the present invention reduces labor costs while increasing application speed over conventional compositions.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIGS. 1A-B illustrate a chart showing a plurality of exemplary compositions according to the principles of the present invention;

FIG. 2 is a schematic cross-section of the UV curable PSA system of the present invention; and

FIG. 3. is a schematic diagram of a system and method for manufacturing the UV curable PSA system of the present invention.

### DETAILED DESCRIPTION

The following description is merely exemplary in nature and is not intended to limit the present disclosure, application, or uses.

The radiation curable pressure sensitive adhesive (PSA) compositions of the present invention provide advantages over prior art adhesives and hot melt compositions. These prior art adhesives and hot melt compositions require the use of heat or moisture to cure the adhesive. However, the radiation curable PSA of the present invention can be cured quickly using a conventional UV radiation source while retaining desirable tackiness and strength properties.

The UV curable PSA compositions of the present invention include a UV curable rubber component, which preferably comprises a styrene-butadiene-styrene block copolymer. An exemplary UV curable styrenic block copolymer for use in the present invention is Kraton™ DKX222CS, commercially available from Kraton Polymers. However, it should be appreciated that other rubbery or block copolymer materials may be used without departing from the scope of the present invention which provide the desired UV curable properties.

The UV curable structural sealant composition also preferably includes at least one plasticizer, at least one stabilizer, at least one antioxidant, at least one tackifier, at least one photoinitiator, and at least one flexibilizer.

The compositions of the present invention may further include substances for flow resistance, bodying agents, and cured strength builders.

The compositions of the present invention may also include a number of conventional additives including, but not limited to, heat stabilizers, colorants including pigments and dyes, rheology modifiers, and/or wetting agents.

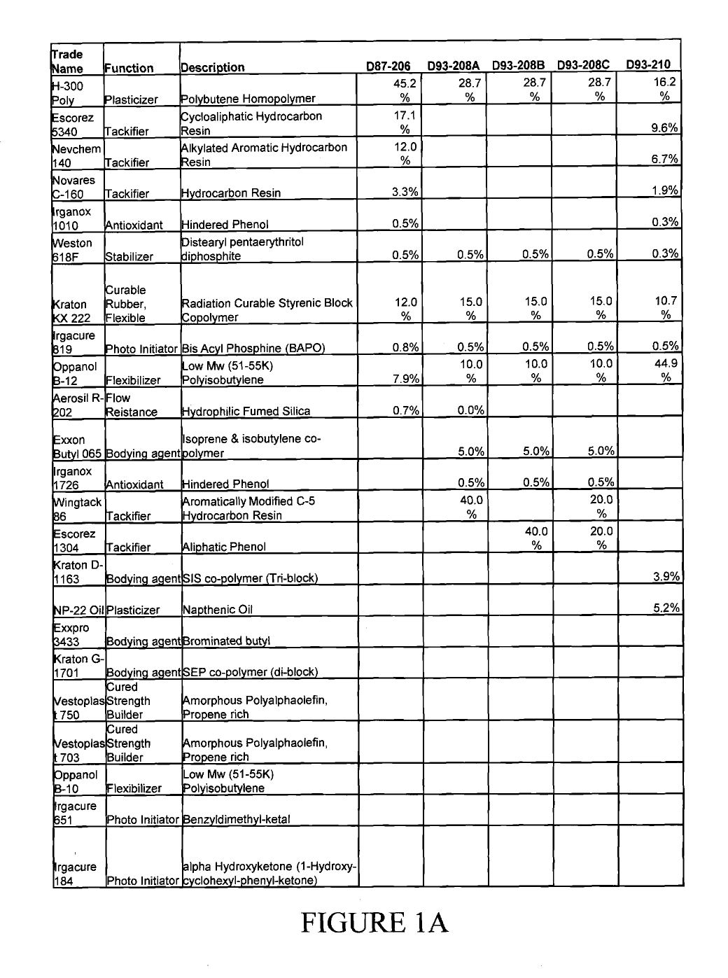

Referring to FIGS. 1A-B, a plurality of exemplary compositions according to the present invention are illustrated in a table format. Each formulation is arranged in columns with amounts of individual components indicated by percent weight. The present invention contemplates that any given component may be substituted by a component listed in the table having a similar function.

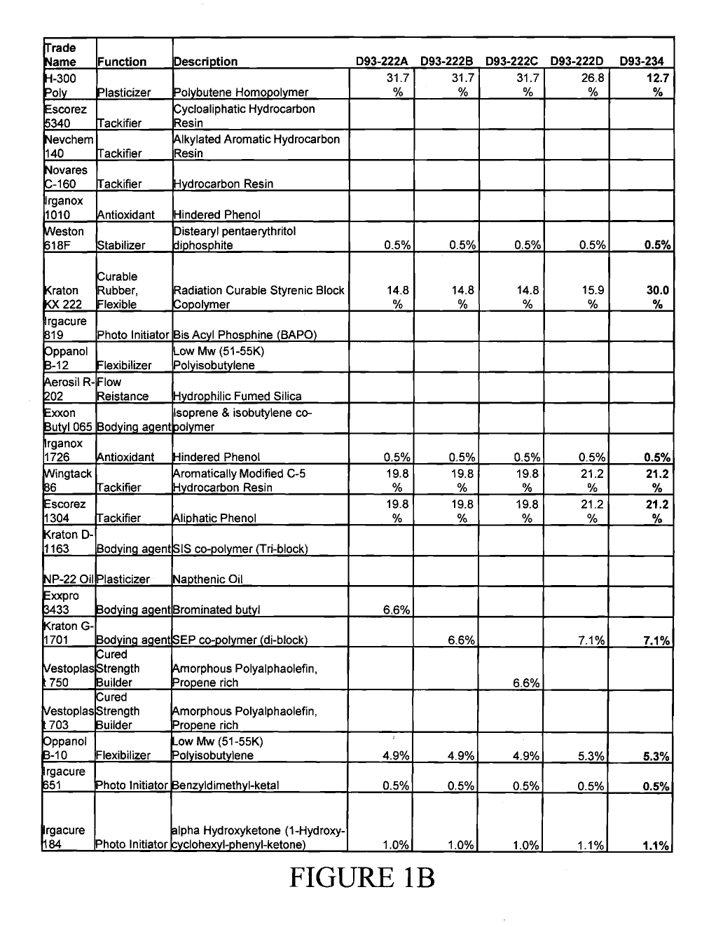

With reference to FIG. 2, a UV curable PSA roofing system is generally indicated by reference number 10. The PSA roofing system includes a plurality of layers including a first layer consisting of a roofing membrane 12. The roofing membrane 12 may consist of a variety of materials including, but not limited to, ethylene propylene diene monomer (EPDM), thermoplastic olefin (TPO), polyvinyl chloride, or modified bitumen. The membrane preferably ranges in thickness from about 0.01 inches to 0.06 inches. The roofing membrane 12 forms the outer surface of a fully assembled roof and protects the roof from water leakage, sun damage, snow damage, and debris.

The UV curable PSA roofing system 10 includes a second layer consisting of the UV curable PSA compositions of the present invention as described above and indicated by reference number 14. The UV curable PSA 14 is adhered and cured to the roofing membrane 12, as will be described in greater detail below. The UV curable PSA layer 14 preferably ranges in thickness from about 0.01 inches to 0.03 inches. The UV curable PSA 14 is formulated to adhere to the roofing deck or substrate, or to another section of a roofing membrane 12 in sections of overlap.

The UV curable PSA roofing system 10 includes a third layer consisting of a release liner or laminate 16. The release liner 16 is attached to the UV curable PSA layer 14 to protect the UV curable PSA prior to adhesion to the roof deck or substrate. The release liner 16 may be selected from any number of commercially available release coated papers or plastic films. The UV curable PSA roofing system 10 is preferably formed in sheets or tapes having various widths, lengths, and thicknesses as required by a given application.

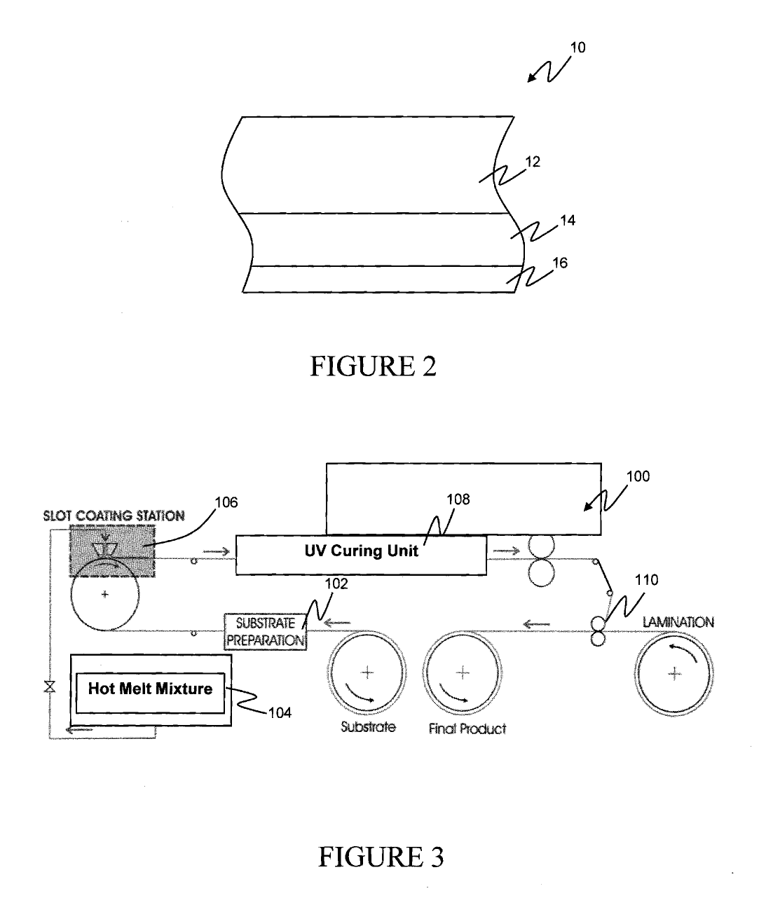

With reference to FIG. 3, a method for manufacturing the UV curable PSA roofing system of the present invention is generally indicated by reference number 100. The method begins when the roofing membrane or substrate is prepared at step 102. This preparation of the roofing membrane may include washing or cleaning, pre-treatment, or coating with an adhesion promoting layer.

The UV curable PSA composition is prepared at step 104. The specific composition is prepared as a hot-melt mixture and the components are mixed using a C-blade or Sigma blade mixer.

The UV curable PSA composition is then layered onto the roofing membrane at step 106 using a hot coating station. The composition is layered onto the roofing membrane preferably using a hot-melt coating method of application in a semi-viscous or viscous state. Various other methods may be employed to layer the composition onto the roofing membrane, including, but not limited to, reverse roll coating, gravure coating, and slot die (slot extrusion) coating.

Once the composition has been layered onto the roofing membrane, a suitable UV source is used to cure the composition to the roofing membrane at step 108. UV or near-UV radiation may be used to cure the composition, and suitable UV sources include UV light such as a UV lamp. Preferred wavelengths range from 240 to 450 nm. However, it should be appreciated that any other curing sources may be used to cure the composition without departing from the scope of the present invention so long as the desired cure is achieved. The desired cure may include a balance of through-cure versus surface cure. This can be accomplished by the choice of photoinitiator or initiators and the use and selection of inerting gasses during cure. Once cured, the composition exhibits good heat and chemical resistances while maintaining the desired tack at its surface.

The release liner or laminate is then applied to the composition at step 110. The release liner protects the UV curable PSA during transportation to an on-site location. Once there, the release liner may be removed and the roofing membrane and UV curable PSA applied to a substrate or roof deck

In order that the invention may be more readily understood, reference is made to the following example which is intended to illustrate the invention, but not limit the scope thereof:

### Example 1

| | | Percent by |
|---|---|---|
| Component | Description | Weight (%) |
| Plasticizer¹ | Polybutene homopolymer | 12.7% |
| Stabilizer² | Distearyl pentaerythritol diphosphite | 0.5% |
| Flexible Curable | Radiation curable styrenic block | 30% |
| Rubber³ | copolymer | |
| Antioxidant⁴ | Hindered phenol | 0.5% |
| Tackifier⁵ | Aromatically modified C-5 hydrocarbon | 21.2% |
| | resin | |
| Tackifier⁶ | Aliphatic phenol | 21.2% |
| Bodying Agent⁷ | SEP co-polymer (di-block) | 7.1% |
| Flexibilizer⁸ | Low Mw (51-55K) polyisobutylene | 5.3% |
| Photoinitiator⁹ | Benzyldimethyl-Ketal | 0.5% |
| Photoinitiator¹⁰ | Alpha-hydroxyketone (1-hydroxy- | 1.1% |
| | cyclohexyl-phenyl-ketone) | |

Exemplary Trade Names:
¹H-300 Poly
²Weston 618F
³Kraton KX 222
⁴Irganox 1726
⁵Wingtack 86
⁶Escorez 1304
⁷Kraton G-1701
⁸Oppanol B-10
⁹Irgacure 651
¹⁰Irgacure 184

The description of the invention is merely exemplary in nature and variations that do not depart from the gist of the invention are intended to be within the scope of the invention. Such variations are not to be regarded as a departure from the spirit and scope of the invention.

1. A pressure sensitive adhesive composition comprising:
at least one radiation curable styrenic block copolymer present in an amount from about 10% to about 30% by weight;
at least one plasticizer present in an amount from about 12% to about 46% by weight;
at least one stabilizer present in an amount from about 0.1% to about 1% by weight;
at least one antioxidant present in an amount from about 0.1% to about 1% by weight;
at least one tackifier present in an amount from about 19% to about 43% by weight;
at least one photoinitiator present in an amount from about 0.5% to about 2.2% by weight; and
at least one flexibilizer present in an amount from about 4% to about 6% by weight.

2. The composition of claim 1 wherein the radiation curable styrenic block copolymer comprises radiation curable styrene-butadiene-styrene block copolymer.

3. The composition of claim 2 wherein the tackifier comprises a first tackifier and a second tackifier present in approximately equal amounts.

4. The composition of claim 3 wherein the first tackifier comprises aromatically modified C-5 hydrocarbon resin and the second tackifier comprises aliphatic phenol.

5. The composition of claim 2 wherein the plasticizer comprises at least one of polybutene homopolymer and napthenic oil.

6. The composition of claim 5 wherein the antioxidant comprises at least one hindered phenol.

7. The composition of claim 6 wherein the photoinitiator comprises at least one of bis acyl phosphine (BAPO), benzyldimethyl-ketal, and alpha hydroxyketone (1-hydroxy-cyclohexyl-phenyl-ketone).

8. The composition of claim 7 wherein the photoinitiator comprises both benzyldimethyl-ketal and alpha hydroxyketone (1-hydroxy-cyclohexyl-phenyl-ketone).

9. The composition of claim 8 wherein the flexibilizer comprises a low molecular weight polyisobutylene.

10. The composition of claim 9 wherein the body agent comprises at least one SEP di-block co-polymer.

11. The composition of claim 1 wherein the radiation curable styrenic block copolymer comprises radiation curable styrene-butadiene-styrene block copolymer in an amount of about 30% by weight, the tackifier comprises aromatically modified C-5 hydrocarbon resin in an amount of about 21% by weight and aliphatic phenol in an amount of about 21% by weight, the plasticizer comprises polybutene homopolymer in an amount of about 13% by weight, the antioxidant comprises hindered phenol in an amount of about 0.5% by weight, the flexibilizer comprises a low molecular weight polyisobutylene in an amount of about 5% by weight, the body agent comprises at least one SEP di-block co-polymer in an amount of about 7% by weight, and the photoinitiator comprises benzyldimethyl-ketal in an amount of about 0.5% by weight and alpha hydroxyketone (1-hydroxy-cyclohexyl-phenyl-ketone) in an amount of about 1% by weight.

12. A roofing system comprising:
a roofing membrane comprising at least one of ethylene propylene diene monomer (EPDM), thermoplastic olefin (TPO), and modified bitumen;
a cured adhesive composition attached to a side of the roofing membrane, the adhesive composition comprising a radiation curable styrenic block copolymer, a tackifier, a plasticizer, a stabilizer, an antioxidant, a photoinitiator, a flexibilizer, and a body agent; and
a removable release liner attached to the adhesive composition.

13. The roofing system of claim 12 wherein the radiation curable styrenic block copolymer comprises radiation curable styrene-butadiene-styrene block copolymer, the tackifier comprises aromatically modified C-5 hydrocarbon resin and aliphatic phenol in approximately equal weights, the plasticizer comprises at least one of polybutene homopolymer and napthenic oil, the antioxidant comprises at least one hindered phenol, the photoinitiator comprises at least one of bis acyl phosphine (BAPO), benzyldimethyl-ketal, and alpha hydroxyketone (1-hydroxy-cyclohexyl-phenyl-ketone), the flexibilizer comprises a low molecular weight polyisobutylene, and the body agent comprises at least one SEP di-block co-polymer.

14. The roofing system of claim 12
wherein the membrane further comprises polyvinyl chloride.

15. The roofing system of claim 12 wherein the adhesive composition has a thickness of about 0.01 inches to about 0.03 inches.

16. A method for manufacturing a roofing system comprising the steps of:
preparing a flexible roofing membrane;
preparing an adhesive composition comprising a radiation curable styrenic block copolymer, a tackifier, a plasticizer, a stabilizer, an antioxidant, a photoinitiator, a flexibilizer, and a body agent;
applying the adhesive composition to a first side of the roofing membrane;
curing the adhesive composition by exposing the adhesive composition to radiation; and
attaching a removable release liner to the cured adhesive composition.

17. The method of claim 16 wherein the step of preparing the roofing membrane includes at least one of washing the first side of the roofing membrane, cleaning the first side of the roofing membrane, and applying an adhesion promoting layer to the first side of the roofing membrane.

18. The method of claim 17 wherein the step of applying the adhesive composition to the first side of the roofing membrane includes the steps of heating the adhesive composition and applying the adhesive composition in a semi-viscous or viscous state.

19. The method of claim 16 further including the step of rolling the flexible roofing membrane, cured adhesive composition, and the removable release liner into a roll.
